(19) United States
(12) Patent Application Publication
(10) Pub. No.: US 2019/0255747 A1
(43) Pub. Date: Aug. 22, 2019

(54) TRIM COMPONENT FOR COVERING AN INTERIOR SPACE OF A MEANS FOR TRANSPORTING PASSENGERS AS WELL AS METHOD FOR PRODUCING SUCH A TRIM COMPONENT

(71) Applicant: MOTHERSON INNOVATIONS COMPANY LIMITED, London (GB)

(72) Inventor: Pierre Pignard, JEBSHEIM (FR)

(73) Assignee: MOTHERSON INNOVATIONS COMPANY LIMITED, London (GB)

(21) Appl. No.: 16/279,239

(22) Filed: Feb. 19, 2019

(30) Foreign Application Priority Data
Feb. 20, 2018 (EP) 18 157 517.6

(51) Int. Cl. B29C 45/14; B29C 53/02

(52) U.S. Cl. CPC B29C 45/1418; B60R 13/0256; B29C 53/02; B29C 45/14688

(57) ABSTRACT

The present invention relates to trim component for covering an interior space of a means for transporting passengers, in particular of a vehicle, comprising a support element which has at least one separation surface and at least one edge-folded section abutting the separation surface, wherein the support element has at least one folded edge which includes at least one edge-folded section. Moreover, the present invention relates to a method for producing such a trim component.

### CROSS-REFERENCES TO RELATED APPLICATIONS

This application claims the priority of European Patent Application Serial No. EP 18 157 517.6, filed Feb. 20, 2018, pursuant to 35 U.S.C. 119(a)-(d), the subject matter of which is incorporated herein by reference.

### BACKGROUND OF THE INVENTION

The present invention relates to a trim component for covering an interior space of a means for transporting passengers as well as a method for producing such a trim component.

The means for transporting passengers is constructed, in particular, as a vehicle, but can also be a ship, an airplane, a train or the like. When in the following the invention is explained in terms of vehicles, the description extends likewise also to other means for transporting passengers such as ships, airplanes, trains and the like.

In all embodiments of the means for transporting passengers, the interior space is covered more or less elaborately to provide a corresponding design of the interior space. The design of the interior space plays an important role especially for vehicles and is an important selling point. Trim components are used for the trim of the interior space, which cover, for example, the doors of the vehicle from the inside. The trim components can also form or be part of the instrument panel or of the trunk or of the side panel coverings.

Trim components include in many cases a support element, which is typically a two-dimensional body with adequate stiffness to withstand the stresses occurring during operation of the vehicle. In the context of efforts to reduce the fuel consumption or electric power consumption of the vehicles, the weight reduction plays an important role. As already mentioned, the support elements are two-dimensional bodies, which often have only a small wall thickness. To further reduce the weight of the support element, its weight per unit area is further reduced. In this context, hybrid lightweight components are increasingly used as trim components, employing various materials, such as plastic, metal, mineral fibers, glass fibers, natural and/or carbon fibers. The required stiffness can be achieved for hybrid lightweight components with very low weight per unit area and hence with very low total weight. In particular, the hybrid lightweight components, but also the conventional sheet-like support elements which include, for example, thermoplastic fiber-reinforced non-woven fabrics or composite such as NFPP (natural fiber-reinforced polypropylene) or GFPP (glass fiber reinforced polypropylene), have low stability at the edges formed by the above-described separation surfaces. In particular, during manufacture and during transport, but also during operation, damage or distortion may occur, so that the trim components can no longer be used and/or need to be replaced. For this reason, sufficient edge stability plays an important role.

The support elements may be made of a random web composed of compressed natural fibers. However, the support elements often do not exhibit the desired visual and/or haptic properties, so that the support elements are provided with a decorative layer. The decorative layer of the trim component is hereby facing the interior space.

There are several known ways for applying the decorative layer on the support element. In the initial state, the support element is provided as a mat. Before the mat is further processed, it must be first calibrated to eliminate, for example, the air contained therein. For this purpose, the mat is heated and compressed. To bring the calibrated mat in the desired shape, it is placed in an open mold, which has an upper tool and a lower tool. The mold is closed by moving the upper tool and the lower tool toward each other, thereby bringing the calibrated mat into the desired shape and forming the support element. The cut material of the calibrated mat is larger than the support element in its finished geometry. The upper tool and the lower tool are designed to, when closing, cut off areas extending beyond the finished geometry. These areas are referred to in the following as edge pieces.

It is sufficient in most cases, to provide the support element only on the side facing the interior space with the decorative layer. The decorative layer can be inserted in the mold together with the support element. The mold tool can compress the decorative layer with the calibrated mat and create a firm connection. Prior to insertion into the mold, the decorative layer can be joined with the calibrated mat, for example through heat treatment by forming a material connection. However, it is still important to ensure that the heat is quickly dissipated to avoid damaging the decor. The decorative layer extending beyond the edge pieces the finished geometry of the trim component the calibrated mat is also separated when closing the mold. As a result, the trim component does not have a decorative layer at the cut surface, which can be visually objectionable when the cut surface is visible from the interior space. In addition, the decorative layer may frequently have a thermal expansion coefficient or shrinkage coefficient different from the support element. The situation may therefore occur that the decorative layer contracts, in particular after the respective trim component has aged and no longer covers the area of the support element adjoining the cut surface, which is visually disadvantageous.

To avoid this situation, the decorative layer may be applied on the support element only after the support element has been removed from the mold. The decorative layer can then also include the cut area and may even extend to the back of the support element so that a contraction does not affect the appearance of the interior space. Such a trim component is known from U.S. Pat. No. 5,925,207 A, JP 59 201 814 A, DE 43 17 234 A1, U.S. Pat. Nos. 5,139,604 A, 5,718,791 A, and DE 10 2014 019 331 A1. However, a further processing step is hereby required, making provision of the trim component more complicated and more expensive.

### SUMMARY OF THE INVENTION

It is an object of an embodiment of the present invention to provide a trim component which is easy to manufacture and which has sufficient edge stability and a low weight. Furthermore, it is the object an embodiment of the invention to provide a method, with which a trim component can be easily manufactured.

This object is attained by a trim component for covering an interior space of a passenger transport vehicle with a support element having a separation surface and an edge-folded section attached to the separation surface, where the edge-folded section is folded over to form a folded edge.

In addition, the object is attained by a method for manufacturing such a trim component with a support element having an edge-folded section, which includes the steps of heating and placing a calibrated mat in a mold having an upper tool and a lower tool, closing the mold by moving at least one of the upper tool and the lower tool and reshaping the calibrated mat to form the support element and heating the support element and bending the edge-folded section to form the folded edge. Advantageous embodiments are recited in the dependent claims.

An embodiment of the invention relates to a trim component for covering an interior space of a means for transporting passengers, in particular of a vehicle, comprising a support element which has at least one separation surface and at least one edge-folded section abutting the separation surface, wherein the support element has at least one folded edge, which includes at least one edge-folded section.

In the following, an edge-folded section is to be understood as a portion of the support element, which is folded over to form a folded edge relative to the rest of the support element. Taken alone, the edge-folded section has essentially the same construction as the rest of the support element, but has as a result of the folding over a different alignment with respect to the rest of the support element. The edge-folded section therefore includes an edge of the support element which can face outward or inward. If the edge faces outwards, then the edge forms the edge of the support element. If the edge faces inwards, it may for example be a cutout of the support element. A folded edge is to be understood as the three-dimensional shape obtained by the folding over at least one edge-folded section. Consequently, the folded edge includes at least one edge-folded section.

As mentioned above, the support element is brought in its desired shape starting from a calibrated mat by opening and closing the tool. The support element is hereby cut to the desired dimension thereby forming the aforementioned edge pieces. It may also be necessary to provide the support element with a cutout. The cutout can also be produced by closing the correspondingly shaped mold. In both cases, a separation surface is formed, where no longer required material is separated from the support element or from the calibrated mat. Thus, the edge-folded section may be provided not only at the outer ends or edges, but also inside the trim component, for example, when the trim component has a cutout for passing therethrough an adjacently component. This is in particular the case for inside door handles (TIB). When the trim component is to be fastened to an adjacent component, it may also be advantageous to provide a folded edge for the reasons explained in more detail below.

Starting from a substantially flat support element, the end face, in particular the separation surface, of the support element no longer runs perpendicular to the main plane of the support element because the edge-folded sections are folded over, but encloses therewith an angle. The stiffness of the trim component at the folded edge is significantly increased, so that high edge stability is achieved. Due to the increased stiffness, the support element can be designed with a smaller wall thickness, thus reducing the weight per unit area. The weight of the entire trim component is reduced. It should be noted that the calibrated mat must be cut to be larger than the size of the edge-folded section, so that the support element has the desired dimensions after provision of the folded edges.

In contrast to the trim components known from the prior art, the support element is part of the edge-folded section. For example, the support element of the trim component known from U.S. Pat. No. 5,925,207 A is no longer reshaped after removal from the mold.

According to a further embodiment, the trim component includes at least one decorative layer applied on the support element, which is folded over at the edge-folded section. In this embodiment, the separation surface can be aligned by suitable bending so that it is not visible from the interior space. This can be achieved in that the edge-folded section is bent away from the side on which the decorative layer facing the interior space is arranged. It is therefore not necessary to cover the separation surface with the decorative layer, which simplifies the production of the trim component. The appearance of the interior space remains unaffected. According to the proposal, the decorative layer may be applied to the mat, both the calibrated as well as to the non-calibrated mat, before the support element is formed. An additional step for connecting the decorative layer to the support element is not necessary.

A further embodiment is characterized in that the support element has at least one predetermined buckling point which delimits the fold-over section with respect to the remaining support element. The predetermined buckling point can be implemented in particular by reducing the wall thickness. For this purpose, the support element can be provided with correspondingly aligned notches or grooves. These can be produced, for example, by suitably shaped projections in the upper tool and/or the lower tool. When the mold closes, the projections are pressed into the deformed mat or into the support element, thus producing the predetermined buckling point. With the predetermined buckling points, the force required to bend the edge-folded sections is reduced. The probability of a break of the support element is minimized.

Furthermore, the predetermined buckling point causes the support element to be bent at the desired location, thus reducing discrepancies between different trim components in mass production. In addition, a certain profile of the folded-over portion can be predetermined by way of the depth and shape of the notches and grooves. Since the predetermined buckling point specifies the desired location, where the support element is to be bent, it also delimits the edge-folded section with respect to the rest of the support element. The predetermined buckling point can also be referred to as a predetermined bending point.

According to another embodiment, the folded-over section forms a fold angle, which is in particular 90° or 180°. These fold angles can be easily produced. In addition, with a fold angle of 90° the separation surface can be aligned so as to face away from the interior space and is hence no longer visible. As already mentioned, the edge-folded section is for this purpose bent away from the side on which the decorative layer is arranged. As a result, the separation surface is obscured by the folded-over section. The fold angle can be specified with a corresponding design of the predetermined buckling point.

In a further embodiment, the folded-over section can form a fold angle of 180° and the folded-over section can at least partially abut the side of the support element facing the decorative layer. The side facing the decorative layer serves as a support surface for edge-folded section, thereby simplifying the bending process. Furthermore, in this embodiment, the support element is folded over similar to a hem. The support element can thus be constructed to have two layers at least in sections of the region of the folded-over section, wherein the fold significantly increases the stiffness.

In a further embodiment, the edge-folded section may enclose a cavity. For this purpose, the support element may be provided with a corresponding number of predetermined bending points or predetermined buckling points. The edge-folded section may form a projection of selectable size for the trim component, thereby flexibly responding to the installation situation in the interior space and specifically improving the appearance of the interior space. In addition, by sizing the cavity, the edge thickness of the support element and the stiffness at the folded edge can be intentionally adjusted.

In a further embodiment, the trim component may have functional elements. Functional elements may be positioning pins, welding domes and the like, with which the trim component can be attached to adjacent components.

An embodiment of the invention relates to a method for manufacturing a trim component according to any one of the afore-described embodiments, wherein the trim component includes a support element with at least one edge-folded section, with the following steps:

Heating and inserting a calibrated mat in a mold with an upper tool and a lower tool,

Closing the mold by moving the upper tool and/or the lower tool and shaping the calibrated mat into a support element, and

Providing at least one folded edge by locally heating the support element and by bending at least one edge-folded section.

The technical effects and advantages that can be achieved with the proposed method correspond to those discussed above for the trim component. In particular, it should be noted that the edges of the support element and hence of the trim component as a whole can be stiffened with the folded edge. The advantages of stiffening the trim component, in particular in region of the edges, are independent on whether a decorative layer is applied to the trim component or not.

As mentioned above, the mat is pressed before molding for calibration and calibrated, which means that its dimensions are defined at a certain temperature. The mat is hereby heated to a calibration temperature.

While the mat is calibrated, heat is applied to a temperature at which forming can be optimally carried out. The calibrated mat heated to the forming temperature is now inserted into the mold and the mold is closed. Closing the mold causes the calibrated mat to be reshaped into the support element.

Depending on the design of the mold, the folded edge can be provided in the mold. If the mold is not designed accordingly, the support element is removed from the mold and the folded edge is produced outside of the mold. When the support element is to be removed from the mold, it must be cooled to a certain temperature in order to avoid a change in its shape caused by opening of the mold and ejection of the trim component from the mold. Therefore, the support element must be heated again to be able to provide the folded edge. However, this is not necessary or it may even be disadvantageous to heat the entire support element. Instead, only local heating takes place, which is to be understood as heating wherein the support element is, for example, heated to a maximum of 10 mm beyond the point where the support element is to be bent for providing the folded edge.

With an appropriate choice of material for the trim component, local heating causes softening of the support element which makes bending possible. In addition, the probability of breakage of the support element is reduced. For this purpose, the trim component may include thermoplastic materials.

In a further embodiment, the method includes the following step:

Providing the support element with at least one predetermined buckling point when closing the mold, and bending at least one of the edge-folded sections by using the at least one predetermined buckling point.

In particular, the predetermined buckling point may be implemented by reducing the wall thickness. For this purpose, the support element may be provided with suitably aligned notches or grooves. These can be produced, for example, by providing the upper tool and/or the lower tool with correspondingly shaped projections. When the mold is closed, the projections are pressed into the deformed mat or into the support element, thereby producing the predetermined buckling points. The predetermined buckling points reduce the force required to bend the edge-folded section. The probability of breakage of the support element is minimized.

Furthermore, the predetermined buckling point causes the support element to be bent at the desired location, thereby reducing deviations between different trim components in mass production. In addition, a certain course of the folding portion can be predetermined with the depth and shape of the notches and grooves. Since the predetermined buckling point defines the desired location where the support element is to be bent, it also delimits the edge-folded section in relation to the remaining support element. The predetermined buckling point can also be referred to as a predetermined bending point.

A further embodiment is characterized by the following step:

Inserting the calibrated mat together with at least one decorative layer in the mold.

In this embodiment, the decorative layer is pressed together with the support element when closing the mold and attached to the support element, thus eliminating a further process step for lamination or decoration of the component. It should be stressed at this point that all forming steps can also be carried out without the decorative layer in place, wherein the decorative layer is, when desired, inserted in the mold together with calibration mat. The trim component can also be installed in a means for transporting passengers without the decorative layer. In order to nevertheless be able to provide a visually attractive appearance of the interior space, the visible side of the trim component can be provided with a pattern, for example similar to embossing. The pattern may be produced when calibrating the mat or when closing the mold.

In a further embodiment of the proposed method, wherein the at least one decorative layer is in contact with a first side of the support element and a second opposite side has no decorative layer, the method may include the following steps:

Local heating of the support element on the first side to a first temperature,

Local heating of the support element on the second side to a second temperature, wherein the first temperature is lower than or equal to the second temperature, wherein

the support element is heated after removal from the mold.

The heating can occur outside of the mold, for example with hot air or with an infrared radiator. The thermal energy acting on the decorative layer is less than the thermal energy acting on the support element. The decorative layer is thus protected from thermal damage, which is particularly important because the layer is typically of higher quality and made of a more heat-sensitive material than the support element. Moreover, heat damage to the decorative layer is immediately visually apparent, which is not the case for the support element. Accordingly, the trim component can be sufficiently strongly heated and then bent with a small applied force, without the risk of visible thermal damage. As already mentioned, it is sufficient to heat the support element only locally, that is, for example, to maximally 10 mm beyond the point at which the support element is to be bent to provide the folded edge. The thermal energy required for providing the folded edge is hereby minimized and the risk of visible heat damage is reduced.

As already mentioned, the edge of the trim component can be stiffened because of the local doubling of the support. Since the hem is plastically deformed and the folding slider performs a shaping function, it is possible to give the edge a specific form in order to make it even more rigid or to implement particular edge functions.

This type of hem may preferably be used when using mats with low weights per unit area (preferably with weights per unit area smaller than 1300 g/m²) in order to stabilize or to stiffen, with the use of lightweight materials, the unstable edges of the trim components (for example, the component edges of a door trim to the inner door panel). This type of hem can be implemented with an already decorated component, but also with a support element lacking a decorative layer. The support element without the decorative layer with such a hem can be decorated in a further process step. In the case, the hem does not operate as a folded edge, but only as edge reinforcement.

This type of hem or fold is particularly applicable to pressed trim components, to pressed and directly back-injected trim components, or to pressed —directly back-injected—directly laminated trim components. This procedure is applicable to all trim components produced from thermoplastic fiber-reinforced non-woven fabrics or composite (for example, NFPP or GFPP). The binder matrix of the support material is preferably polypropylene (PP); however, any thermoplastic material can be used, which can be produced in the form of fibers.

In a further embodiment, the method includes the following step:

Injection of functional elements with the mold closed.

Functional elements can be positioning pins, welding domes and the like, with which the trim component can be attached to adjacent components. The functional elements may also be produced in a “one-shot process”, so that the manufacturing process is not significantly prolonged.

### BRIEF DESCRIPTION OF THE DRAWINGS

Exemplary embodiments of the invention will be explained in more detail below with reference to the accompanying drawings, which show in:

FIGS. 1A to 1H the main steps of a first method for producing a first trim component known from the prior art,

FIGS. 2A and 2B selected steps of a second method for producing a second trim component known from the prior art,

FIGS. 3A to 3H the main steps of a proposed first method for producing a first trim component according to the invention, and

FIGS. 4A to 4C selected steps of a proposed second method for producing a second and third inventive trim component, each shown in schematic diagrams.

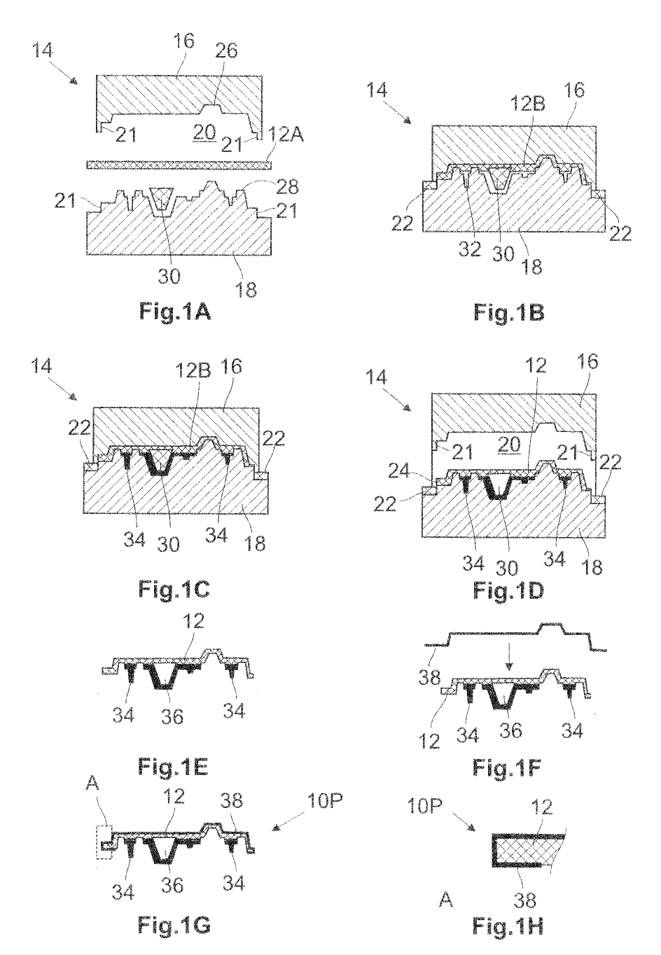

FIGS. 1A to 1H show in form of schematic diagrams the main steps of a first method for producing a first trim component 10P known from the prior art.

### DETAILED DESCRIPTION OF PREFERRED EMBODIMENTS

The trim component 10P (see FIG. 1G) includes a support element 12, which is present in the initial state as a mat 12A, for example, as a natural fiber mat. The mat 12A is first calibrated in a manner not here shown in detail, heated and, as shown in FIG. 1A, inserted into an open mold 14, which has an upper tool 16 and a lower tool 18. The upper tool 16 and lower tool 18 can be moved towards one another and away from one another. In the open state, the upper tool 16 and the lower tool 18 open a gap 20, which is sized such that the heated, calibrated mat 12A can be inserted into the mold 14.

The upper tool 16 and the lower tool 18 each have trimming edges 21. The calibrated mat 12A is sized in the initial state such that it extends outwardly beyond the trimming edges 21, but not beyond the mold 14 when inserted into the mold 14.

After the calibrated mat 12A has been inserted into the open mold 14, the mold is closed 14, as shown in FIG. 1B. For this purpose, the upper tool 16 and lower tool 18 are moved towards one another. Closing the mold 14 has the effect that the calibrated mat 12A is first shaped into a reformed mat 12B. The trimming edges 21 cooperate such that they separate, when closing, edge pieces 22 from the calibrated mat 12A. The regions formed as a result of the separation of the calibrated mat 12A and of the reformed mat 12B are in the following referred to as separation surfaces 24 (see for example FIG. 1D).

The upper tool 16 and lower tool 18 have recesses 26 and bumps 28. Furthermore, the mold 14 has cores or sliders 30. The calibrated mat 12A conforms to the shape of the recesses 26 and bumps 28, to the extent that the recesses 26 are designed to come into contact with the calibrated mat 12A when the mold 14 closes. Several of the recesses 26 of the lower tool 18 are designed to form a cavity 32 when the mold 14 is closed. The slider 30 can be introduced into this cavity 32. In the step illustrated in FIG. 1C, the cavities 32 are filled with an injection-molding material, whereby the functional elements 34, such as positioning and/or attachment sections or ribs, are overmolded or back-molded on the bottom side of the deformed mat 12B in relation to FIGS. 1A to 1H. After the functional elements 34 are completed, a trim component 10P is produced, wherein the deformed mat 12B represents the support element 12 of the trim component 10P. A clear distinction between the deformed mat 12B and the support element 12 is possible, but not necessary. As soon as the deformed mat 12B has permanently assumed the desired shape, it forms the support element 12.

As shown in FIG. 1D, the mold 14 is subsequently opened and the slider 30 is retracted. The support element 12 can now be removed from the mold 14. The edge pieces 22 are discarded or recycled. FIG. 1E shows the support element 12 with a molded functional element 34. The respective functional element 34 has a hollow region 36 where the slider 30 was arranged.

Subsequently, a decorative layer 38 is applied to the side of the support element 12, which does not have any of the functional elements 34, with reference to the top side in FIGS. 1A to 1H. The decorative layer 38 can, for example, be glued to the support element 12. As seen from FIG. 1F, the decorative layer 38 projects laterally beyond the support element 12. In this way, the decorative layer 38 can be applied not only on the upper side of the support element 12, but also on the separation surfaces 24 and on an edge region of the bottom side. This is shown in FIGS. 1G and 1H, with FIG. 1H showing an enlarged view of the section A defined in FIG. 1G of the now finished trim component 10P. In this way, the following advantages can be achieved: Firstly, the separation surfaces 24 are covered by the decorative layer 38, so that the trim component 10P has the same appearance from the side as from the top side. This allows the trim component 10P to be installed also in an interior space of a means for transporting passengers and to be visible from the side, without impairing the visual appearance of the interior space. On the other hand, the decorative layer 38 may have a different coefficient of shrinkage, which may cause the decorative layer 38 to contract more strongly than the support element 12, so that the decorative layer 38 uncovers again surface portions of the support element 12 that were originally covered. Since in this case the uncovered surface portions are located on the bottom side of the support element 12, they are not visible from the interior space, so that the appearance is not adversely affected.

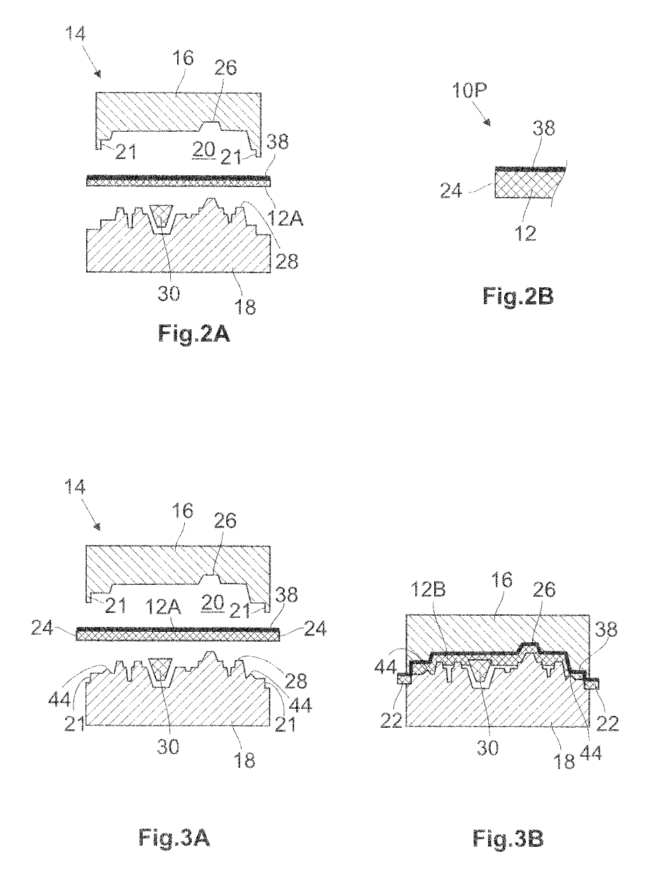

FIGS. 2A and 2B show in form of schematic diagrams selected steps of a second method for manufacturing a second trim component 10P known from the prior art. FIG. 2B shows an enlarged detail of the second trim component 10P corresponding to FIG. 1H. The mold 14 corresponds to the mold shown in FIGS. 1A to 1D.

In contrast to the first method, with the second method the decorative layer 38 is inserted into the opened mold 14 together with the previously heated calibrated mat 12A. The subsequent steps correspond largely to those illustrated in FIGS. 1B to 1D. The decorative layer 38 may be coated with a hot melt adhesive or may even have such properties itself, so that the decorative layer 38 is attached to the support element 12 during the reshaping steps. The pressure generated when the mold 14 is closing and the residual heat can be sufficient to attach the decorative layer 38 to the support element 12. It must be ensured that, on the one hand, enough heat is available for attaching the decorative layer 38 to the support element 12 and, on the other hand, not too much heat is introduced into the support element 12 and the decorative layer 38 so as not to damage the decorative layer 38. It is not necessary to carry out further steps for applying the decorative layer 38 to the support element 12 after the mold 14 has been opened.

As explained for the first method, the upper tool 16 and lower tool 18 are designed so that they separate, during closing, the edge pieces 22 from the calibrated mat 12A by forming separation surfaces 24. However, since the decorative layer 38 has already been inserted into the open mold 14 together with the calibrated mat 12A, it is not possible, unlike with the first method, to cover the separation surfaces 24 and the edge portions of the bottom side with the decorative layer 38 (see FIG. 2B in comparison to FIG. 1H). The advantages achievable by covering the separation surface 24 and the edge areas cannot be realized with the second method or not without further steps.

The trim component 10P produced in this way is an “off-tool” part, meaning that it has its desired shape after removal from the mold 14 and does not require further processing. Such manufacturing method is also called a “one-shot” method.

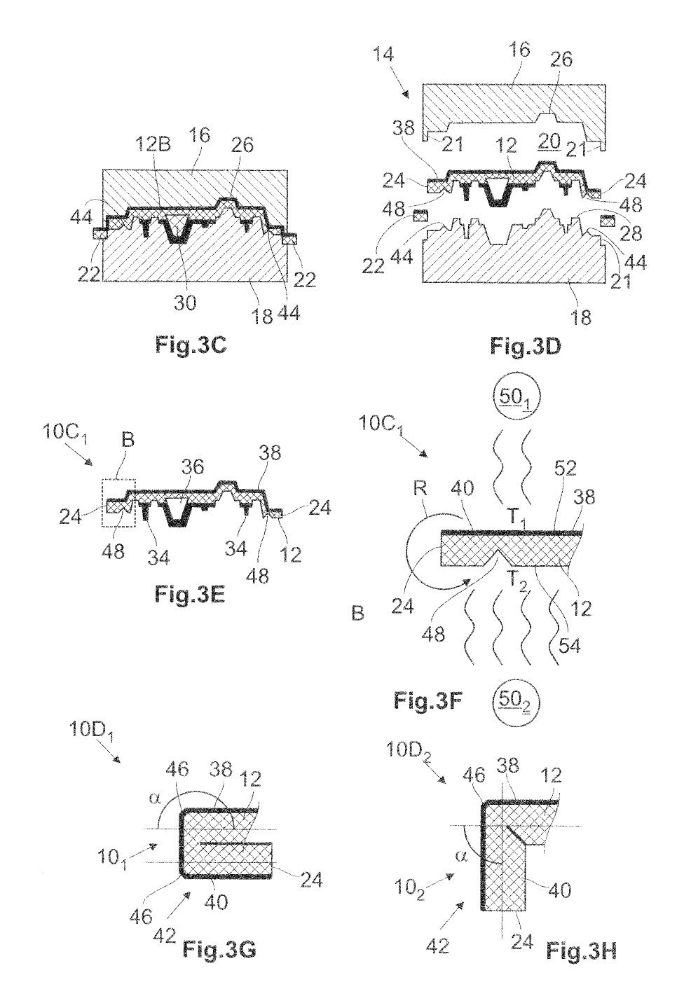

FIGS. 3A to 3F illustrate the main steps of a first embodiment of a method according to the invention for producing a proposed trim component 10D₁ according to a first exemplary embodiment (see FIG. 3G) and a proposed trim component 10D₂ according to a second exemplary embodiment (see FIG. 3H).

The upper tool 16 corresponds to the upper tool depicted in the FIGS. 1A and 2A. However, the lower tool 18 has projections 44, which serve to provide the support element 12 with predetermined buckling points 48, as will be discussed in more detail later.

Also in this embodiment according to the invention, the decorative layer 38 is inserted in the open mold 14 together with the calibrated mat 12A, so that the proposed trim component 10C₁ upon removal from the mold 14 corresponds to the trim component which is removed from the mold 14 according to the second method known from the prior art. Accordingly, the steps shown in FIGS. 3A through 3D correspond substantially to those steps shown in FIGS. 1A to 1D. FIG. 3E shows the support element 12 with the decorative layer 38 applied thereon after removal from the mold 14. As can be seen, the support element 12 has two predetermined buckling points 48, which are produced because the lower tool 18 has correspondingly shaped projections 44.

However, the trim component 10C, can also be used in situations where no decorative layer 38 is necessary. In this case, the calibrated mat 12A can also be inserted into the mold 14 without the decorative layer 38. As mentioned above, when the mold 14 closes, the edge pieces 22 are separated from the calibrated mat 12A (see in particular FIG. 3D), forming the separation surfaces 24. As seen from FIG. 3F, the separation surfaces 24, on the one hand, and the predetermined buckling points 48, on the other hand, delimit an edge-folded section 40. FIG. 3F shows schematically the detail B defined in FIG. 3E on an enlarged scale.

After removal from the mold 14, the edge-folded section 40, which in the illustrated example includes the support element 12 and the decorative layer 38 attached thereto, is bent by using the predetermined buckling points 48 by a certain fold angle in the direction R indicated in FIG. 3F, so that a folded edge 42 is formed in the region of at least one end of the support element 12 (see FIGS. 3G and 3H). The trim component with the folded edge 42 is designated as 10D₁. Consequently, the edge-folded section 40 is the section of the support element 12 abutting the separation surface 24, which is moved relative to the rest of the support element 12 during bending. As seen in FIGS. 3D and 3E, the support element 12 includes at least one of the above-mentioned predetermined buckling points 48. Providing the predetermined buckling point 48 simplifies bending of the support element 12 and provision of the folded edge 42. In addition, the precision of the folded edge 42 can be increased since the region in which the support element 12 is to be bent can be specified more accurately. In the illustrated exemplary embodiment, the predetermined buckling points 48 delimit the edge-folded section 40 towards the inside of the support element 12.

In the first exemplary embodiment of the trim component 10D₁ according the invention illustrated in FIG. 3G, the fold angle is 180°, so that the trim component 10D₁ is folded much like a hem. In the region of the respective end, the support element 12 is then constructed at the folded edge 42 in two layers, since the edge-folded section 40 rests on the bottom side of the support element 12.

In the second exemplary embodiment of the trim component 10D₂ according to the invention illustrated in FIG. 3H, the fold angle is 90°. In this case, the edge-folded section 40 does not rest on the bottom side of the support element 12.

In both cases, provision of the folded edges 42 causes that the trim components 10D₁ and 10D₂, when seen from the side, to be provided with the decorative layer 38. The separation surface 24, which is also not covered by the decorative layer 38 in the proposed first trim component 10C₁, is aligned by bending in such a way that it is no longer visible from the side. Furthermore, in both cases, the support element 12 is reinforced in the region of the respective folded edge 42.

As can be seen in FIG. 3F, the trim component 10C₁ can be heated after removal from the mold 12 and before bending the edge-folded section 40. For this purpose, a first heat source 50₁ and a second heat source 50₂ are provided, between which the trim component 10C₁ can be positioned after removal from the mold 14. The top side of the support element 12 on which the decorative layer 38 rests and which faces the first heat source 50₁, will hereinafter be referred to as the first side 52, whereas the opposite bottom side, which does not have a decorative layer 38, will be referred to as the second side 54. The second side 54 faces the second heat source 50₂. The heat sources 50₁, 50₂ can for example be implemented as infrared radiators or as a source of hot air. Due to the heat-up of the trim component 10C, and in particular of the support element 12, the support element 12 is softened, facilitating bending. In addition, the risk of breakage of the support element 12 is eliminated.

By providing two heat sources 50₁, 50₂, the trim component 10C₁ can be heated to a first temperature T on the first side 52, and to a second temperature T₂ on the second side 54. In the illustrated exemplary embodiment, the heat sources 50₁, 50₂ are adjusted so that the first temperature T₁ is lower than the second temperature T₂. In particular, this protects the frequently temperature-sensitive decorative layer 38 from thermal damage, while at same time rendering the support element 12 so soft that it can be bent without breaking.

Moreover, by heating the edge-folded sections 40 before bending, the edge-folded section 40 abuts at a folded edge angle of 180° not only the second side 54 of the support element 12, but also fuses with the second side 54 when the support element 12 consists of a material with corresponding properties. The trim component 10D₁ is hereby further reinforced in the region of its ends.

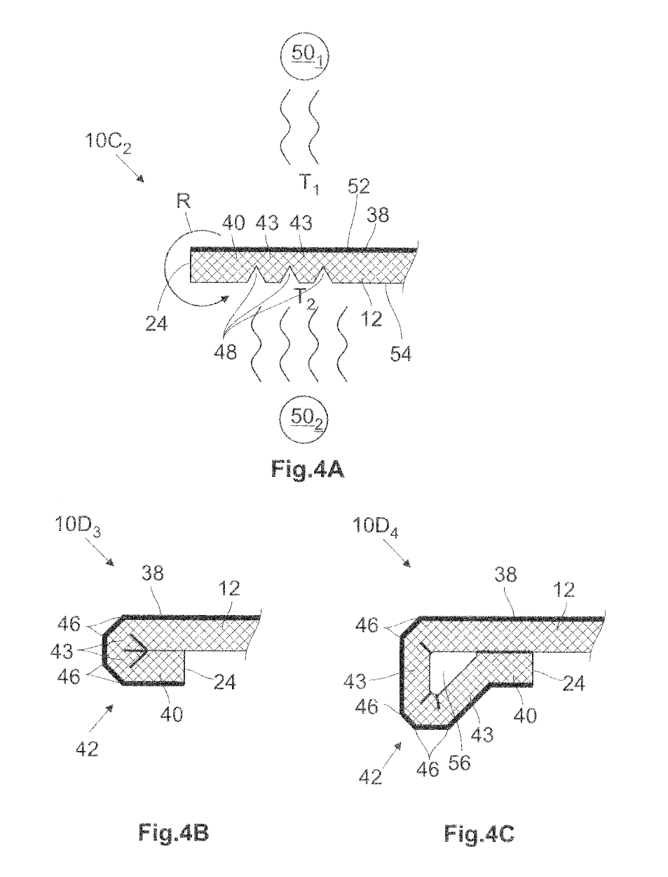

FIG. 4A illustrates a second embodiment of the proposed method wherein the support element 12 may have more than one predetermined buckling point 48 in the region of an edge. In the illustrated exemplary embodiment, the support element 12 has three predetermined buckling points 48. As already mentioned above, the edge-folded section 40 is delimited by the separation surface 24 and the adjacently arranged predetermined buckling point 48. However, since the support element 12 shown in FIG. 4A has three predetermined buckling points 48, these also delimit two additional edge-folded sections 43 in relation to the rest of the support element 12. In this way, the bending process can be specifically influenced and folded edges 42 with special geometries can be produced. 10C₂

FIG. 4B illustrates a third exemplary embodiment of a trim component 10D₃ according to the invention with a support element 12 having three predetermined buckling points 48. Accordingly, one edge-folded section 40 and two more folded edge sections 43 are present. In particular, by providing more than one predetermined bending points 48, the thereby formed folded edge 42 may include additional bending edges 46. The unmarked fold angle is 180°, as in the first exemplary embodiment.

FIG. 4C illustrates a fourth embodiment of a trim component 10D₄ according to the invention. By providing a corresponding number of predetermined buckling points 48 and a corresponding process control when bending the edge-folded sections 40 and the two other edge-folded sections 43, the folded edge 42 can be designed so that it encloses a cavity 56, thereby additionally stiffening the trim component 10D₄ at the folded edge 42. The unmarked fold angle is 180°, as in the first exemplary embodiment.

Both in the third embodiment of the trim component 10D₃ and in the fourth embodiment of the trim component 10D₄, the edge-folded section 40 of the folded edge 42 rests on the support element 12, so that the trim components 10D₃ and 10D₄ are constructed at that location in two layers, thereby additionally increased the stiffness.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A trim component for covering an interior space of a passenger transport vehicle, comprising
a support element comprising a separation surface and an edge-folded section attached to the separation surface,
wherein the edge-folded section is folded over to form a folded edge.

2. The trim component of claim 1, further comprising a decorative layer applied on the support element with the decorative layer being bent over at the folded edge.

3. The trim component of claim 1, wherein the support element comprises a predefined buckling point which delimits the edge-folded section with respect to a remaining section of the support element.

4. The trim component of claim 1, wherein the edge-folded section encloses a bending angle of 90° or 180° with respect to a surface of the support element.

5. The trim component of claim 1, wherein the edge-folded section encloses a bending angle of 180° relative to a surface of the support element and the edge-folded section at least partially contacts the surface of the support element.

6. The trim component of claim 1, wherein the folded edge encloses a cavity.

7. The trim component of claim 1, further comprising functional elements.

8. A method for manufacturing a trim component covering an interior space of a passenger transport vehicle, wherein the trim component comprises a support element having an edge-folded section, the method comprising the steps of:
Heating and placing a calibrated mat in a mold having an upper tool and a lower tool,
Closing the mold by moving at least one of the upper tool and the lower tool and reshaping the calibrated mat to form the support element, and
Heating the support element and bending the edge-folded section to form a folded edge.

9. The method of claim 8, further comprising the following steps:
Providing the support element with a predefined buckling point when closing the mold, and
Bending the edge-folded section at the predefined buckling point.

10. The method of claim 8, wherein the support element comprises a decorative layer.

11. The method of claim 10, wherein decorative layer rests on a first side of the support element, whereas an opposite second side of the support element lacks a decorative layer, further comprising, after the support element has been removed from the mold, the following steps:
Locally heating the support element on the first side to a first temperature, and
Locally heating the support element on the second side to a second temperature which is higher than the first temperature.

12. The method of claim 8, further comprising the following step:
Over-molding functional elements on the support element while the mold is closed.
